(19) United States
(12) Patent Application Publication
(10) Pub. No.: US 2022/0286663 A1
(43) Pub. Date: Sep. 8, 2022

(54) APPARATUS AND METHODS FOR SCANNING

(71) Applicant: LOUIS GARAS, NORTH YORK (CA)

(72) Inventor: LOUIS GARAS, NORTH YORK (CA)

(21) Appl. No.: 17/685,342

(22) Filed: Mar. 2, 2022

Related U.S. Application Data
(60) Provisional application No. 63/155,401, filed on Mar. 2, 2021.

(51) Int. Cl. H04N 13/254; H04N 13/296

(52) U.S. Cl. CPC H04N 13/254; H04N 13/296

(57) ABSTRACT

A method and apparatus for scanning a human body has an array of light sources for directing light of uniform radiant intensity at the body and an array of cameras for capturing light emanating from the body. A controller limits the capture of light to a common fraction of a second. Sets of 2D image data are generated corresponding to the light collected from respective cameras. 2D image data corresponding to overlapping images is subject to image processing to find and match key points and to develop tracks corresponding to the key points. Mapping software is used to develop a point cloud or other image representation of the scanned body from the tracks.

### CROSS REFERENCE TO RELATED PATENTS

This application claims priority under 35 USC 119(e) from U.S. Provisional Patent Application Ser. No. 63/155,401 entitled “APPARATUS AND METHODS FOR SCANNING” filed Mar. 2, 2021.

### FIELD OF THE INVENTION

This invention relates to apparatus and methods for generating a 3D scan of a body to collect image data on the body's shape and/or surface appearance. The apparatus and methods have particular but not exclusive application to scanning a live body such as a human body to obtain a point cloud representation thereof.

### BACKGROUND

Human body scanning has various applications in fields such as medicine, sports, the garment industry, movies and animation, security, and sculpture. In the past decades, technological advances have enabled diagnostic studies to reveal more detailed information about the internal structures of the human body. X-rays, magnetic resonance imaging (MRI), computed tomography (CT), and ultrasounds are commonly used to study physiology and anatomy to aid in the diagnosis and monitoring of a multitude of disease states.

However, for some applications, only external measurements of the body are important. Medical professionals widely use size, shape, texture, color and skin surface area to assess nutritional status and developmental normality, to diagnose numerous cutaneous diseases, and to calculate the requirements for drug, radiotherapy, and chemotherapy doses; body measurements are also used for the production of prostheses. From a medical perspective, 3D scanning applications are commonly used in such fields as epidemiology, diagnosis, treatment and monitoring.

3D scanning technologies used in human body scanning are often inaccurate because the body has features of complex shape and because it is inherently non-stationary. Errors may occur due to general body movement and to small displacements such as breathing and blinking that occur during the scanning process. In addition, the time taken to obtain measurements of the shape and surface of a body sufficient to obtain a usable scan can be considerable.

Large and expensive scanners are known which operate by means of cameras which are moving vertically along rods to capture a scan of the entire body, the average period of time to complete such a scan being of the order of 17 seconds. Relatively smaller, lower cost scanners are known which are operated by moving an imaging subsystem around the body being imaged. 3D body scanners for obtaining human body physical or physiological information tend currently to be expensive items of equipment located at hospitals, clinics or similar institutions. There is a need for a low-cost scanner that is accurate and can be deployed and used regularly in, for example, a home environment.

### SUMMARY OF THE INVENTION

### BRIEF DESCRIPTION OF THE DRAWINGS

FIG. 1 is a side view of a light source and camera supporting frame according to an embodiment of the invention.

FIG. 2 is a top view of the frame of FIG. 1.

### DETAILED DESCRIPTION OF THE INVENTION INCLUDING THE PRESENTLY PREFERRED EMBODIMENTS

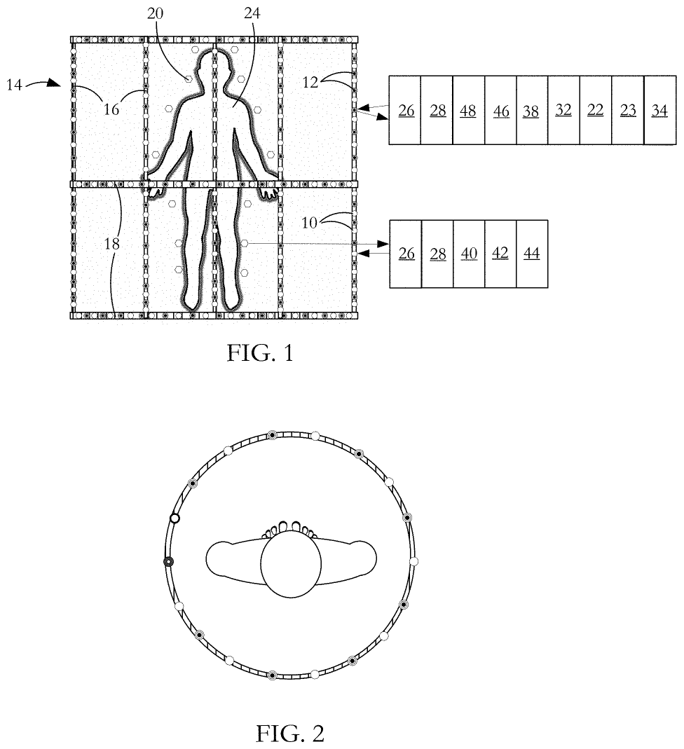

Referring to FIGS. 1 and 2, there are shown elements of a scanner of relatively simple and inexpensive construction which can be used to obtain precise detailed information about physical and physiological characteristics of a human body. The scanner uses a stereophotogrammetry technique in which 3D coordinates of surface positions on a body are estimated using measurements made on a plurality of 2D images generated from different camera positions. A common key point is identified on each image and, using image processing software, a virtual line from the camera location to the key point is constructed. The image processing software is then used to find the intersection of the virtual lines for the two images to determine the 3D location of the key point.

Because of the non-static nature of the human body, a short scanning time is particularly important. In one implementation, 100 cameras are used to capture image data in a common, short time period of the order of one thousandth of a second. The cameras, control modules and LED light sources are placed at specific positions around the body being scanned and a multiplicity of overlapping images are captured from different angles around the body. Cameras and associated control modules are used to capture the images and transmit them at high speed to a server where a high quality point cloud representation of the body is generated. For an explanation of point cloud imaging, reference is made to the website at https://en.widipedia.org/wiki/Point_cloud which is hereby incorporated herein by specific reference. Exemplary software for generating a point cloud image from scanning data is available from Topcon Positioning Systems, Inc. under the product name MAGNET Collage http://www.youtube.com/watch?v=MXK]rzH2e6U, and from AUTODESK under the product name, ReCap™ Pro http://www.youtube.com/user/autodeskrecap, both of which websites and their associated product descriptions and operating instructions are hereby incorporated herein by specific reference.

In one embodiment of the invention, light sources 10 and cameras 12 are mounted on a rigid frame, an exemplary frame 14 being shown FIGS. 1 and 2. The frame has a series of vertical poles 16 which are equally spaced around the surface of a notional cylinder having a central vertical axis and a series of rings or hoops 18 mounted on or otherwise made integral with the poles. In use, a bottom ring 18 rests on the ground, a top ring 18 is located at the top end of the poles 16 and, in the 3-hoop example shown, the middle ring is at the vertical center of the frame. The poles 16 are spaced a sufficient distance from the cylinder axis that a person can stand inside the frame 14. In another implementation, the poles are unequally spaced. In one example, two adjacent poles are spaced sufficiently from each other to enable a person to be scanned to enter and exit the frame interior. In another implementation, the frame is lowered around a person to be scanned and then is lifted from around the person when the scan is complete.

A lighting set-up is adopted in which the space within the frame 14 is effectively bathed in uniform light by a ‘lining’ of LED light sources 10. In one embodiment, a greater number of light sources 10 than cameras 12 are mounted on the frame 14. In an alternative embodiment, the cameras 12 outnumber the light sources 10. In yet another alternative, the light sources 10 outnumber the cameras at one region of the frame 14 but not at another region. In one embodiment and to the extent permitted by cost and available real estate, the number 42, luminous intensity 40 and positions 44 of the light sources 10 are selected to create uniform radiant intensity in the frame interior so that lighting conditions are, to the extent possible, the same from every camera angle. Primary selection is done using known mathematical formulas that estimate camera coverage based on the attributes of the cameras being used. The selection can be tuned using light sensors 20 to measure the radiant intensity at specific positions in the frame interior and appropriately adjusting the number, luminous intensity and/or position of one or more of the light sources. In one embodiment, the sensors 20 and associated control circuits elements are present within the frame 14 but are removed before a scanning operation is performed so as not to affect the illumination of the body or the capture of light from it. Positions of the sensors 20 can be selected to match a generalized shape, size and position of the body to be scanned because lighting variation outside the volume of the body to be scanned will not adversely affect the images obtained. Although light in the body space may be substantially uniform in the absence of the body, the presence of the body, especially if irregularly shaped as in the case of the human body, will mean that there are surface areas of the body that have relatively high illuminance and surface areas that are in shadow.

In one embodiment, each of the cameras 12 has an electronic shutter arrangement 22 in which light collectors are switched on for a fraction of a second, common to all of the cameras, and then are switched off. In this way, light emanating from the body being scanned is captured only for that fraction of a second: the scan period. Camera controller 23 operates to ensure that the scan period starts and ends at exactly the same time for the many cameras 12. In one implementation, the overall control involves introducing compensation for different signal transit times in the camera control circuits.

Mounting the light sources 10 and the cameras 13 on a common frame is a convenience but is not essential. It is preferable however that the frame 14 and cameras 12 are configured and positioned so as not to affect illumination of the body 24 in such a way as would detract from the accuracy of the 3D point cloud image eventually generated from the body scan 2D image data. Similarly, the frame and the light sources are configured and positioned so as affect to the least extent possible the camera capture of light from the body in such a way as to cause a similar loss of accuracy in the generated point cloud representation. In FIGS. 1 and 2, only the positions of the exemplary light sources and cameras are shown. No directional axes are shown either for a camera or a light source. However, in practice, both the cameras and the light sources are orientated respectively to receive light from the body 24 and to direct light at the body.

To fix the cameras 12, the light sources 10 and associated elements such as control elements at the frame 14, vibration-absorbent fasteners/holders 26 are used. In one implementation, mountings for the fasteners/holders use passive vibration isolators. In another implementation, the mountings use active vibration isolators. Several designs of passive and active isolators are described at https://en.widipedia.org/wiki/Vibration_isolation#Semi-active_isolation, the teachings of which site are hereby incorporated by reference.

In operation, one image is taken by a particular camera in a fraction of a second which means that only vibration in that fraction of a second can adversely affect image quality. In one implementation, electronic camera shutters are used in preference to mechanical shutters to further reduce the risk of camera vibration during light capture.

In a set-up procedure, light sources 10 in selected mounting locations may be used initially to illuminate a space to be occupied by the body 24 to be scanned and then an assessment made of regions within the frame that depart from a desired level of radiant intensity. Additional light sources are then positioned at unoccupied mounting locations or removed from occupied mountings to render the radiant intensity more uniform while still maintaining the radiant intensity above a desired threshold. As an alternative to adding or taking away light sources, the position of a light source is adjusted, for example, to bring it closer or further from the body surface area of interest or to move it laterally across that surface area. For such adjustment, the light source mountings can be of a sort to permit a limited amount of x, y, z and/or angular adjustment of the light source with linear and/or angular micromotors 28 for effecting required light source movement, and radiant intensity detectors for use in calculating the extent and direction of movement required. In one implementation, the micromotors 28 and the light sensors 20 are connected and operated in a dynamic network. In another alternative, the luminous intensity or other characteristic of one or more of the light sources is adjusted. In a further embodiment, similar linear and/or angular micromotors 28 are used to adjust any one or more of the cameras.

Light emanating from a body may consist of light which contributes positively to the quality and accuracy of the resulting point cloud data representation or it may be light that detracts from that quality and accuracy. For example, in additional to reflected light, there may be extraneous light such as refracted, diffracted and interfering light. Further, in spite of adjustment, there may still be some variation in radiant intensity within that part of the frame to be occupied by the body to be scanned. Overall, light quality within the frame influences the quality of the point cloud representation that is eventually obtained. With increasing use of the system, the nature of some light artefacts and how to reduce their effect becomes apparent. Appropriate software adjustments are made to remove or reduce negative impact light or to compensate for the negative effects of that light.

The desired point cloud data character/quality may be different as between different commercial and non-commercial applications; for example, a point cloud representation desirable for a medical application may be different from a point cloud representation for the same body that is desirable for a retail application. Appropriate software adjustment of image data is employed to tailor the point cloud representation to the particular application.

For ease of construction and low cost, the system uses light sources 10 that are identical LEDs having the same luminous intensity. However, in one alternative, the lighting system has two or more sets of light sources 10A, 10B, each set providing lighting at a different radiant intensity level from the other sets. Several power supplies are used to power the controllers. In another alternative, the lighting system has two or more sets of light sources 10C, 10D, each set providing lighting at an optical emission bandwidth different from the optical emission bandwidth of the other sets. In one implementation, the cameras 12 are configured so that one set of cameras 12A captures light at one optical emission bandwidth and another set of cameras 12B captures light only at another optical emission bandwidth.

The scanning process begins with capturing image data from different angles around the body being scanned with camera locations and controllable 32 fields of view being chosen to ensure significant area overlap between pairs of image data sets 34 generated from different camera angles. The process of capturing images is initiated by sending a user command to the camera shutter arrangements from the camera controller to initiate light capture. The effect of any signal delay introduced, for example, by a wireless router or otherwise is eliminated by locally synchronizing execution of the initiate light capture command by the camera and control units. One example of camera shutter synchronization is shown in U.S. Pat. No. 10,091,431 (Park et al.), the disclosure of which patent is hereby incorporated by specific reference. An optical method for camera shutter synchronization is described in US Published Patent Application 20030133018 (Ziemkowski), the disclosure of which published patent application is hereby incorporated by specific reference. The camera controllers are alternatively hard wire connected to an overall system controller. The cameras capture respective images within a common fraction of a second and upload corresponding image data either through the camera controllers or directly to the main server.

Owing to the non-rigidity of the human body and to displacements during the scanning process, capture time is an important parameter in human body scanning. In one exemplary embodiment, the system uses a sufficient number of cameras 12 to acquire the required geometric and texture data in 0.001 seconds. This acquisition time is short enough effectively to freeze the scene and to avoid errors in the reconstructed model which would otherwise exist due to displacements inevitably occurring in a longer scanning process. The acquisition time is also long enough to get sufficient light to generate useful images with commercially available cameras.

An accurate 3D reconstruction for the purposes of generating a point cloud of a scanned body requires overlap between pairs of adjacent 2D images. Each of a particular pair of cameras therefore has a field of view sufficiently wide to provide a desired amount of overlap at a commonly imaged area of the body surface. Because there is a trade-off between field of view and image resolution, the camera fields of view are not so wide as to lose important detail from the captured image data. Conversely, the cameras 12 are not configured with an over-narrow field of view which would mean that a very large number of cameras would have to be used with an increase in the required amount of image post-processing. Cameras in the array can have different fields of view indicated by feature 32 and/or different resolution capabilities indicated by feature 38. For example, camera set-up may be such as to obtain high resolution data from one specific part of the body and lower resolution data from a different part of the body.

Another trade-off exists between the illuminance of a surface part of the body being scanned and the capture period for light emanating from that surface part. The camera shutter speed must be high in order to reduce the amount of unintentional body motion that can take place during the scan. In this sense, it is advantageous that the cameras have a very fast and common shutter speed or period. Cameras having an electronic shutter speed down to 1/32000 sec. are known. However, as the light capture period reduces, the level of light captured in that period also reduces. But to process overlapping image data, a desired illuminance threshold of the surface part of the body being scanned must be exceeded. Testing of the particular system is implemented to reduce the shutter speed commensurate with obtaining enough captured light to develop a high quality point cloud data representation of the scanned body. Electronic shutters are generally preferred because there is no attendant vibration when the shutter opens and closes, unlike a mechanical shutter. However, especially with vibration isolators, a mechanical shutter can be used.

External camera parameters such as the total number of cameras, camera positions, direction of optical axes, fields of view and focal lengths, and internal operating parameters which depend on the specific camera design each influence the nature of the point cloud representation of the scanned body that is obtained. Depending on the desired representation of the point cloud, camera parameters can be altered with a view to changing the appearance of that point cloud.

The radiant intensity of light within the frame is configured so that an illuminance threshold level is exceeded at key points on the body to be scanned. This enables capture of sufficient light from the body by the cameras to enable generation of a quality point cloud. In one embodiment, the shape of the body to be scanned is approximated beforehand and the number, luminous intensity and/or position of the light sources is adjusted to ensure that illuminance threshold is exceeded.

The scanner system includes hardware and software for camera control and image data processing. Camera control includes operations such as sending commands by the operator, receiving and performing commands at the camera controllers, sending captured images to the main server, and saving image data in specific files. These operations are undertaken automatically by the system run-time program.

The combined output of the cameras is a set of 2D images, each 2D image being of part of the body and with a significant degree of overlap, for example 60%, with adjacent images. To extract a 3D point cloud representation of the scanned body, the captured images are processed in several steps using various algorithms embodied in commercially available software. The software is also used to extract and factor into the image processing sequence camera parameters such as camera position 42, direction of view 48, field of view 36, and focal length 46.

Known image processing software, as a first step, establishes correspondence between adjacent images as a prelude to constructing the 3D representation. A first image processing step is detecting key points of each image and extracting appropriate features to match with key points of overlapping images. To establish correspondence, the key features such as corner points are identified in pairs of images using, for example, the scale-invariant feature transform (SIFT) or the speeded-up robust features algorithm (SURF). The detected features are then matched using, for example, software embodied in the known Lukas-Kanade tracker, with spurious outliers being filtered out using, for example, the known random sample consensus (RANSAC) algorithm. Tracks connecting sets of matching key points are generated from the multiple images, and a fundamental matrix, being a 3×3 mathematical matrix relating corresponding points in the 2D images, is generated for each track. The fundamental matrices are subsequently used to derive parts of the 3D point cloud with mapping software being used to calibrate the geometric relationship of all points of the point cloud to each other.

Low cost, micro storage devices are used to store and install operating system software for the camera controllers and are used also for temporarily storing captured image data from the associated camera before transmission to the main digital image processor. Allowing for off-the-shelf parts to be used in the construction frame structure and components contributes to the low cost of the structure. More expensive structures in which camera control and image storage is predominantly handled away from the structure are also contemplated. A main server transmits commands to/from the camera controllers using a wireless router with server hosted software being used for processing the image data.

Any or all of the following physical measurements may be extracted from the 3D point cloud created for each human body profile: height, hat size, neck size, arm length, inseam, waist, breast, belly, hips, shoe size. In addition, any or all of the following physiological measurements can also be extracted from the point cloud: foot contours, eye color, hair color, skin pigmentation, hair loss, distance between eyes, changes in chest profile as between ends of the breathing-in and breathing-out cycles, heart rate, blood pressure, hand grip strength, walking gait, posture, fingers circumference. The point cloud and information derived from the point cloud is stored at a central database and is accessible by the owner of the point cloud or authorized person through a password protected account. In one implementation, a 3D avatar of the account holder is created and viewed by them upon logging into their account.

The account holder has certain profile data recorded at the main server to enable secure access and to prevent inadvertent disclosure of body information stored at the server. Profile data typically includes name, gender, age, zip code and a unique indicator for the account holder. Users may have this indicator printed on a credit-card-style card to enable them to give a retailer or a member of the medical profession access to their point cloud and derivative information. Body data is made available only to the profile holder and authorized users with data access by way of standard biometric processes including fingerprint scanning and/or eye scanning and/or face recognition processes. The individual corresponding to the body profile information can access their profile by logging into the profile at any time. While address and contact information is editable by the User, body physical and physiological information is in read-only format and not editable by the User. For authorized commercial interests, data may be accessed in any of a number of formats including profile raw data on any given profile or profiles and generating statistical data the full physical/physiological profile records. Other commercial interests are permitted to build software applications to provide access to profile data through a standard application protocol interface. In one example, a mobile app allows a system user to try on clothes virtually without having to enter a store.

Whereas the illustrated embodiments of the invention have been described in the context of scanning the human body with light sources and cameras mounted on a cylindrical frame, there are many different shapes and sizes of human body, and a frame that departs from absolute cylindricality may be tailored to such shapes and sizes. In one implementation, the frame is barrel or hourglass shaped with the cameras and light sources distributed over the notional shell of the shape. In another implementation, the frame has an elliptical cross-section so as more nearly to resemble the average cross-sectional shape of a human body. The invention may be used to construct a point cloud of any reasonably sized object, whether animate or inanimate. A frame or other means for fixing light sources and cameras can be tailored to provide a surrounding shell of lights and cameras, the shell, for example, being an expanded, approximated version of the body surface to be scanned. A body to be scanned can be suspended within the frame instead of resting on the ground.

As well as eliminating displacements, the extremely fast scanning procedure allows its use to measure changes in body shape or appearance. One such change may be the difference that takes place between full breath exhalation and full breath inhalation. In this case, separate scans are used to show the difference between breath in and breath out chest shape. A detector can be used to sense chest condition and to initiate and complete the scan in period corresponding to points in the respiratory cycle. In another embodiment, a much larger period between scans is used to measure body shape change over time.

What is claimed is:

1. A method of scanning comprising:
operating light sources of a first array thereof to direct light at the body,
operating cameras of a second array thereof to capture light emanating from the body,
operating a controller to limit the capture of light to a substantially common fraction of a second,
generating sets of 2D image data, each set of 2D image data corresponding to the light collected from a respective one of the cameras, and
processing the data of the 2D data sets to generate a first 3D image of the body.

2. The method of claim 1, further comprising setting the position, luminous intensity and number of the light sources in the array so as to provide substantially uniform radiant intensity at a notional surface area representative of an area of the body.

3. The method of claim 2, further comprising preadjusting the luminous intensity of at least one of the light sources in the array to improve uniformity of radiant intensity at the notional surface area.

4. The method of claim 2, further comprising preadjusting the number of the light sources in the array to obtain a desired radiant intensity at the notional surface area.

5. The method of claim 2, further comprising preadjusting the position of at least one of the light sources in the array to obtain a desired radiant intensity at the notional surface area.

6. The method of claim 1, wherein the body is a human body and the array light sources are at positions on a notional surface shape that is generally cylindrical.

7. The method of claim 1, further comprising reducing vibration of at least one of the cameras using a vibration isolator.

8. The method of claim 1, wherein the light sources include a first light source having a first luminous intensity and a second light source having a second luminous intensity, the first luminous intensity different from the second luminous intensity.

9. The method of claim 1, wherein the light sources include a third light source having a first optical emission bandwidth and a fourth light source having a second optical emission bandwidth, the first optical emission bandwidth different from the second optical emission bandwidth.

10. The method of claim 9, further comprising operating one of the cameras to collect light at the first optical bandwidth and operating another of the cameras to collect light at the second optical bandwidth.

11. The method of claim 1, further comprising generating a second image for the body corresponding to illumination of the body over a subsequent second fraction of a second, and comparing the first and second images to show a difference in body shape occurring over an interval between the first fraction of a second and the second fraction of a second.

12. The method of claim 1, wherein the 3D image is a point cloud image.

13. Apparatus for scanning a body comprising a first array of light sources positioned to direct light at the body, a second array of cameras positioned to capture light emanating from the body, a controller operable to limit the capture of light to a substantially common fraction of a second, a converter for generating digital 2D image data sets from the captured light, each set of digital 2D image data corresponding to the light collected from a respective one of the cameras, and a digital processor operable to process the data of the 2D data sets to generate a 3D image of the body.

14. The apparatus claimed in claim 13, wherein by the number of the light sources and the positions and luminous intensity thereof, the light sources effect substantially uniform radiant intensity at a notional surface area representative of an area of the body.

15. The apparatus claimed in claim 14, wherein the light sources and the cameras are mounted on a frame.

16. The apparatus claimed in claim 15, wherein the frame is a cylinder having a first diameter and the notional surface is a cylinder having a second diameter less than the first diameter.

17. The apparatus claimed in claim 13, further comprising a vibration isolator to reduce vibration of at least one of the light sources and the cameras.

18. The apparatus claimed in claim 17, wherein the vibration isolator is one of a passive isolator and an active isolator.

19. The apparatus claimed in claim 13, wherein the image is a point cloud image.
